(19) United States
(12) Patent Application Publication
(10) Pub. No.: US 2008/0284157 A1
(43) Pub. Date: Nov. 20, 2008

(54) Tamper Evident Identification Documents

(76) Inventors: Sani Muke, Victoria (AU); Philip John Fox, Victoria (AU)

Correspondence Address: GREER, BURNS & CRAIN, 300 S WACKER DR, 25TH FLOOR, CHICAGO, IL, 60606, US

(21) Appl. No.: 11/910,192

(22) PCT Filed: Mar. 23, 2006
(86) PCT No.: PCT/AU2006/000390

§ 371 Date: Apr. 8, 2008

(30) Foreign Application Priority Data
Mar. 29, 2005 (AU) 2005901522

(51) Int. Cl. B42D 15/10

(52) U.S. Cl. 283/86

(57) ABSTRACT

A tamper evident security document including: a transparent substrate; an ink receptive coating applied to at least one side of the substrate, said coating including a laser markable additive dispersed therein; at least one laser formed marking or image created in the coating by exposure of the laser markable additive to laser radiation; and printed data applied to the ink receptive coating; wherein the marking or image in the coating is removed or destroyed upon an attempt to alter the printed data.

This invention relates to security documents and is particularly, but not exclusively concerned with identification documents such as passports, driver licences, identity cards and the like. However, the invention may also have application to other types of security documents, such as banknotes, cheques, credit cards, etc.

It is known to provide security documents such as banknotes or the like with a wide variety of security devices which provide verification of authenticity and protection against copying and counterfeiting. In the case of passports, identity cards or the like, particularly in view of requirements for increased level of security, it is desirable to provide the security document with biometric images and/or personalised markings that are protected from fraudulent alteration.

It is also desirable to provide a tamper evident security document with optical security devices that are difficult to copy or reproduce.

It is further desirable to provide effective methods of manufacturing tamper evident security documents.

According to a first aspect of the invention there is provided a tamper evident security document including:

a transparent substrate;

an ink receptive coating applied to at least one side of the substrate, said coating including a laser markable additive dispersed therein;

at least one laser formed marking or image created in the coating by exposure of the laser markable additive to laser radiation; and

printed data applied to the ink receptive coating;

wherein the marking or image in the coating is removed or destroyed upon an attempt to remove or alter the printed data.

According to second aspect of the invention, there is provided a method of manufacturing a tamper evident security document including the steps of:

providing a transparent substrate;

applying an ink receptive coating to at least one side of the substrate, said coating having a laser markable additive dispersed therein;

creating at least one marking or image in the ink receptive coating by irradiating the laser markable additive with laser radiation; and

applying printing ink to the ink receptive coating to form printed data, wherein the ink at least partially penetrates the ink receptive coating so that the laser formed marking or image in the coating is removed or destroyed upon an attempt to remove or alter the printed data.

The ink receptive coating may be opaque, but is preferably transparent or translucent so that the printed data is visible from both sides of the security document.

The ink receptive coating is preferably adapted for printing by digital output devices, such as inkjet printers or laser toners.

Preferably, the ink-receptive coating is an inkjet receptive coating. The inkjet receptive coating may be formed from a polymer-based material which is adapted to absorb inkjet printing inks. Examples of such materials include modified acrylic-based polymers.

In one preferred formulation, the inkjet receptive coating includes a modified acrylic polymer, water and isopropyl alcohol. The acrylic polymer is preferably present in an amount falling substantially within the range from about 10% to about 15% by weight of the total weight of the formulation. The balance of the formulation including the modified acrylic polymer before the laser markable additive is added may comprise a mixture of water and isopropyl alcohol, preferably at a ratio of about 5:1. The pH of the formulation may be from about 3.5 to about 4.0 and it is preferably cationic to make it receptive to anionic inkjet dyes.

The laser markable additive may be such that it forms a monochrome marking in the ink receptive coating when exposed to laser radiation. Commercially available laser markable additives, such as inorganic water dispersible pigments marketed by Sherwood Technology, may be used. Examples of such pigments include: Datalase (Trade Mark) which forms a monochrome grey/black marking when exposed either to a 10.6 μm CO₂ laser or to a 355 nm UV laser at fluences of 100-200 on mJ/cm²; and Digilase (Trade Mark) which is markable with near infrared (NIR) lasers in the range of wavelengths from about 800-1064 nm at fluences of 100-200 mJ/cm².

The laser markable additive is preferably added to the ink receptive coating in concentrations falling substantially within the range from about 10-30%, and more preferably 15-25% by weight of the total weight of the formulation

An inkjet receptive coating as described above is normally transparent, but becomes translucent when the laser markable additive is added. The coating may be applied to the transparent substrate in any one of a variety of printing methods, including gravure, bar (reverse gravure), kiss coating, screen and flexographic printing, and reverse roll coating. Typical coatings may be applied in a dry weight from about 2-10 gsm, more preferably 4-8 gsm.

The laser formed marking or image in the ink receptive coating is preferably an optical security element and more preferably is optically variable. In one embodiment, the optical security element is a micro-image and a lenticular array or an array of microlenses is provided on the security document for viewing the micro-image.

In another embodiment, the laser formed marking or image is an optically variable security element in the form of a plurality of interlaced images which are viewable through a lens array or a printed line screen with different images of the optically variable security element being viewable at different viewing angles.

Preferably, the security document includes a lens array, such as a semi-cylindrical lens array or an aspherical micro-lens array.

In a further embodiment, the laser formed optically variable security element may take the form of an array of micro-images which when viewed through a micro-lens array create a floating image effect, also known as moire magnification.

The lenticular array or array of microlenses may be applied to one side of the substrate either before or after the laser formed marking or image is created in the ink receptive coating. If applied before, the laser formed marking or image may be created by exposure of the ink receptive coating to laser radiation which passes through the lenticular array or array of microlenses.

The lenticular array or the array of microlenses may be applied to the same side of the substrate as the ink receptive coating, but more preferably is applied to the opposite side of the substrate from the ink receptive coating.

In a still further embodiment, the laser formed marking or image may be provided on one side of the document to form a first part of a see-through composite image, with a second part of the see-through composite image provided on the opposite side of the document. The second part of the see-through image does not have to be a laser formed marking or image, and may be provided by printing or using another laser marking method.

In yet another embodiment, the security document may include a plurality of layers, each including a different colour forming pigment. When each layer is exposed to laser radiation of a particular frequency a coloured part of an image can be created in the layer and a multi-coloured image can be formed by different coloured image parts in different colours when two or more layers are superimposed, as described in International Patent Application No. PCT/AU2004/001757, the contents of which are incorporated herein by reference. At least one of the colour forming layers may take the form of an ink receptive coating which is adapted to absorb printing inks. Alternatively, a further ink receptive coating including a laser markable additive may be provided in which a laser formed optical security element and printed data may be formed.

According to a third aspect of the invention there is provided a tamper evident security document including a transparent substrate,

a plurality of laser markable layers, each including a different colour forming pigment;

coloured laser formed part images formed by laser marking in the laser markable layers which part images together constitute a multi-coloured biometric image when superimposed;

a coating including a laser formed permanent image,

wherein an attempt to alter or remove the laser formed permanent image results in removal or destruction of at least one of the laser markable layers and part of the laser formed multicoloured biometric image formed therein.

According to a fourth aspect of the invention, there is provided a method of manufacturing a tamper evident security document including the steps of:

providing a transparent substrate;

applying a plurality of laser markable layers on at least one side of the substrate, each layer including a different colour forming pigment;

exposing each of the laser markable layers to laser radiation to form coloured part images in different colours in the laser markable layers, the coloured part images together constituting a multi-coloured biometric image;

applying another laser markable coating on the same side of the substrate as the laser markable layers; and

laser forming a permanent image in the laser markable coating in such a manner that an attempt to alter or remove the permanent image in the laser markable coating results in removal or destruction of at least one of the laser markable layers including part of the laser formed multi-coloured biometric image formed therein.

In this method, different laser marking processes may be used for forming the laser formed multicoloured biometric image and for forming the laser formed permanent image.

The coating in which the permanent image is laser formed may be an ink receptive coating, preferably an inkjet receptive coating, which includes a laser markable additive so that printed data can be applied to the ink receptive coating. The laser markable additive may be of the type described in the first aspect of the invention. In this case, the permanent image may be laser formed in the coating in similar manner to that described with reference to the second aspect of the invention. For example, a laser markable additive which forms a monochrome grey/black marking when exposed to a CO₂ laser, a UV laser or an infrared laser may be used. Alternatively, the laser markable coating in these latter aspects of the invention need not necessarily be an inkjet receptive coating.

The colour forming pigments which produce different colours in the laser markable layers may be selected from pigments which develop a colour when irradiated with a UV laser, or those which develop a colour when irradiated with infrared laser radiation, eg IRIODIN laser sensitive pigments.

A tamper evident security document in accordance with the aspects of the invention is particularly suitable for use in identification documents containing personal information, such as a passport, driver licence, credit card or identity card containing a photograph of the bearer. In this case, the laser formed images or markings may include a biometric image of the bearer of the document, and the printed data and/or permanent image in the laser markable coating may include variable personalised data, such as information identifying the name, nationality, date of birth etc. of the bearer. Thus, any attempt to remove or alter the personalised data will also result in removal or destruction of the laser formed image.

It will, however, be appreciated that the invention is also applicable to other types of security documents, such as banknotes, cheques, certificates, entrance tickets or other tokens and articles requiring a tamper evident image for authentication and/or protection against copying or theft.

Various embodiments of the present invention will now be described, by way of example only, with reference to the accompanying drawings, in which:

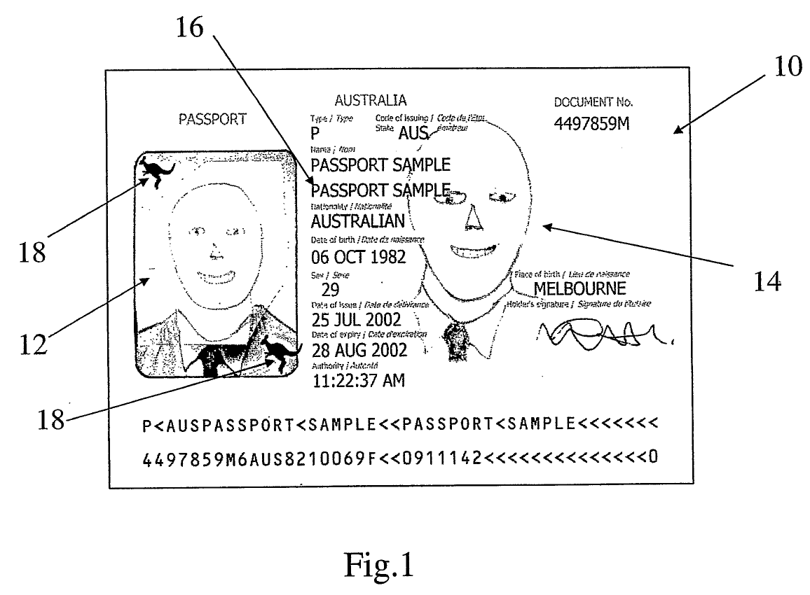

FIG. 1 is a plan view of a security document in accordance with the invention;

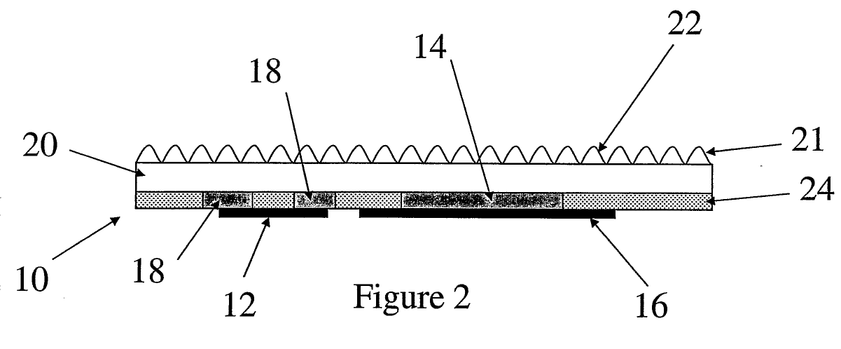

FIG. 2 is an enlarged schematic cross-sectional view through the security document of FIG. 1;

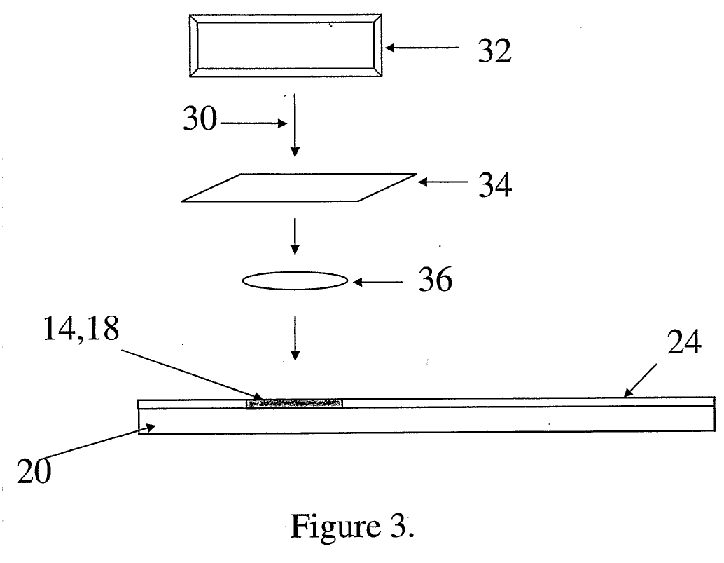

FIG. 3 is a schematic cross-sectional view showing a method of forming markings in a security document having an inkjet receptive layer including a laser markable additive;

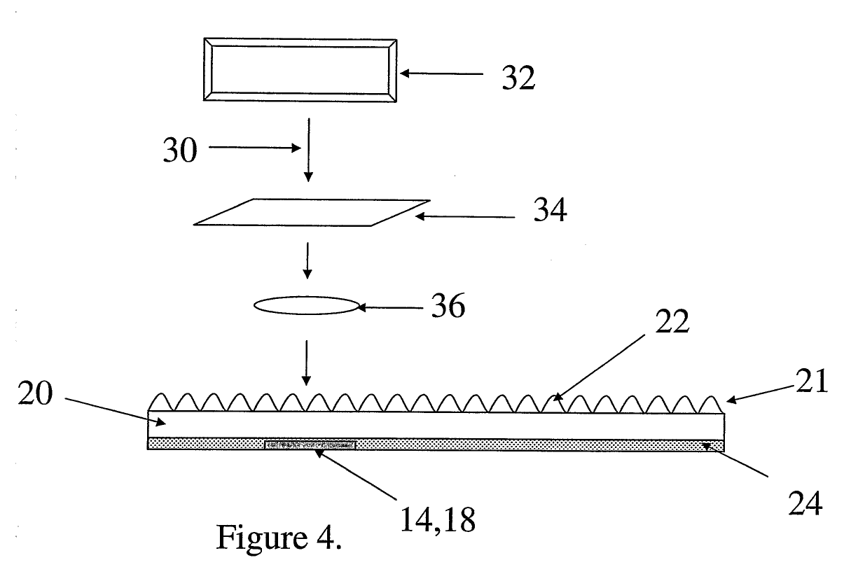

FIG. 4 is a schematic cross-sectional view of an alternative method of forming laser markings or images in the inkjet receptive layer;

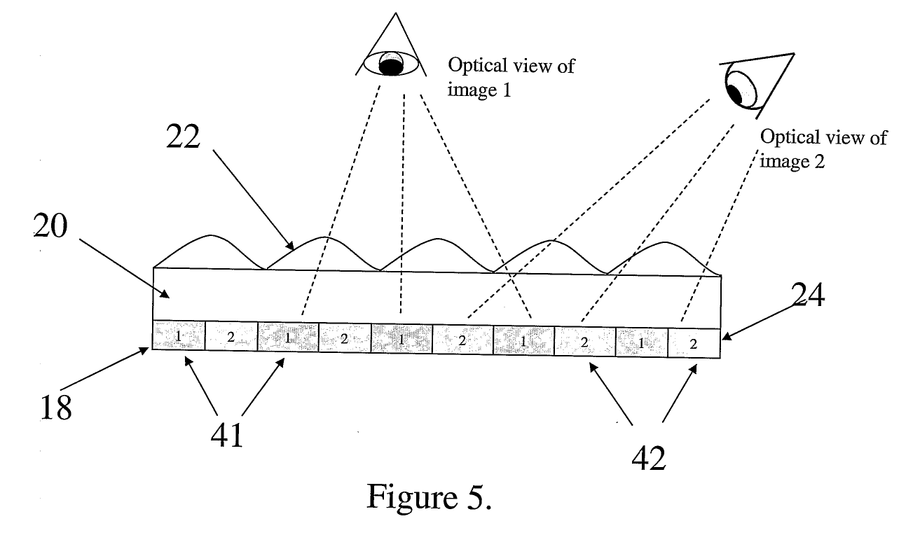

FIG. 5 is an enlarged schematic cross-sectional view of a security document having an interlaced image and a lens array;

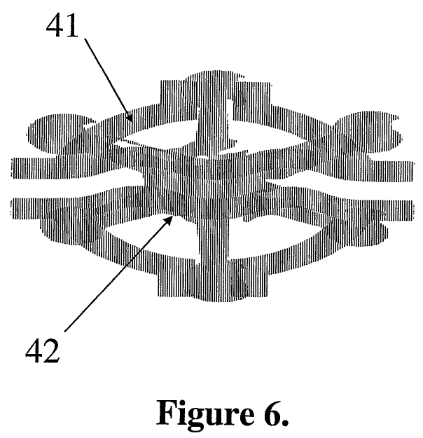

FIG. 6 is an example of an interlaced image which can be formed in the security document;

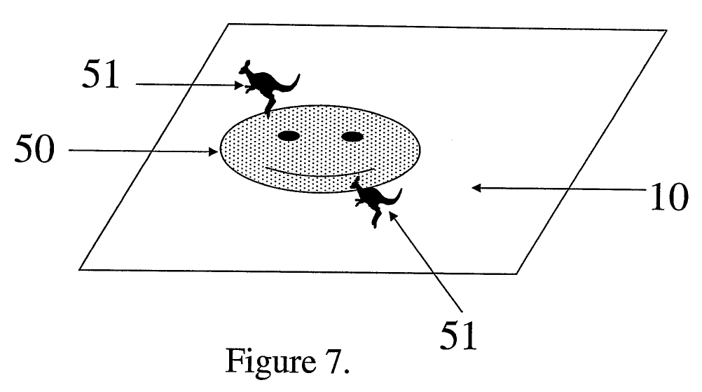

FIG. 7 is a schematic perspective view showing a variable interlaced image and a fixed image viewable at a first predetermined angle;

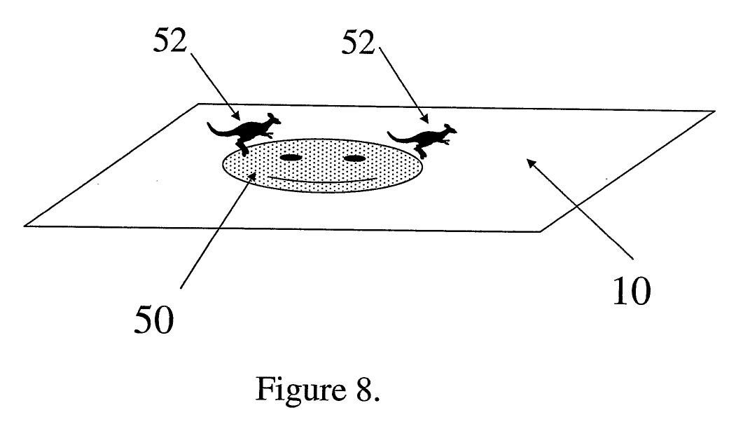

FIG. 8 is a schematic perspective view showing the variable interlaced image viewable at a second predetermined angle;

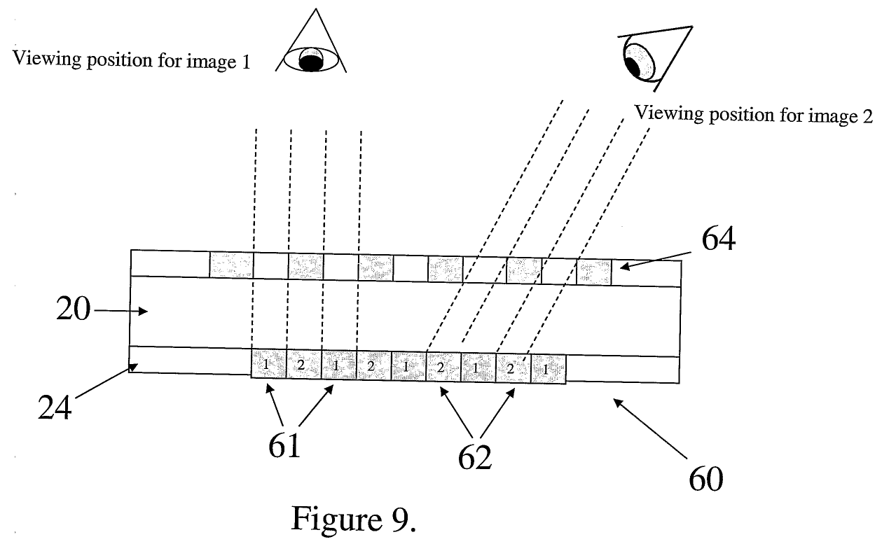

FIG. 9 is an enlarged schematic cross-sectional view of a security document having an interlaced image and a printed screening device;

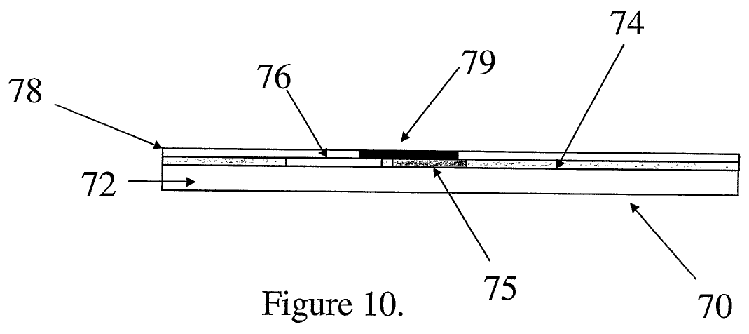

FIG. 10 is a schematic cross-sectional view of a security document having a clear window in an inkjet receptive layer;

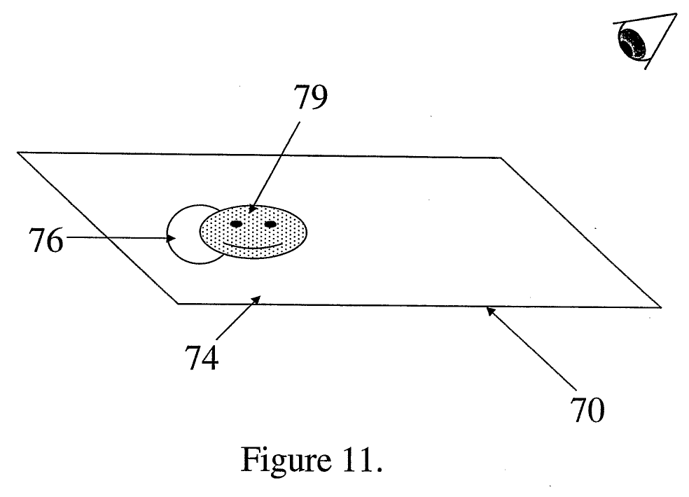

FIG. 11 is a perspective view of the security document of FIG. 10 having an inkjet printed biometric image;

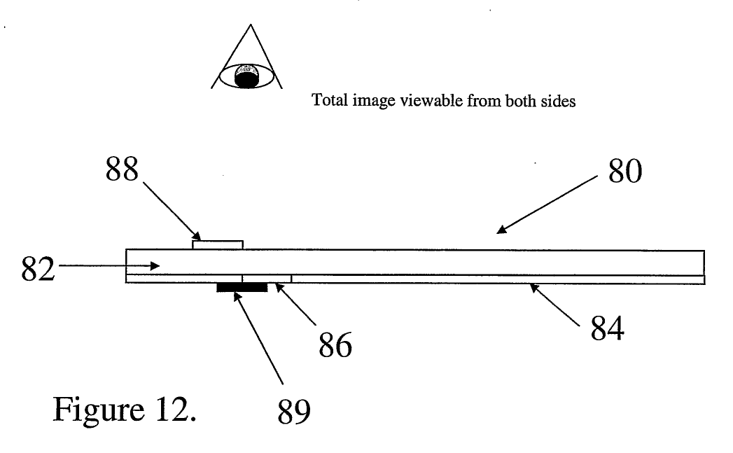

FIG. 12 is a schematic cross-sectional view of a security document having a see-through composite image provided by first and second parts of the image on opposite sides of the substrate; and

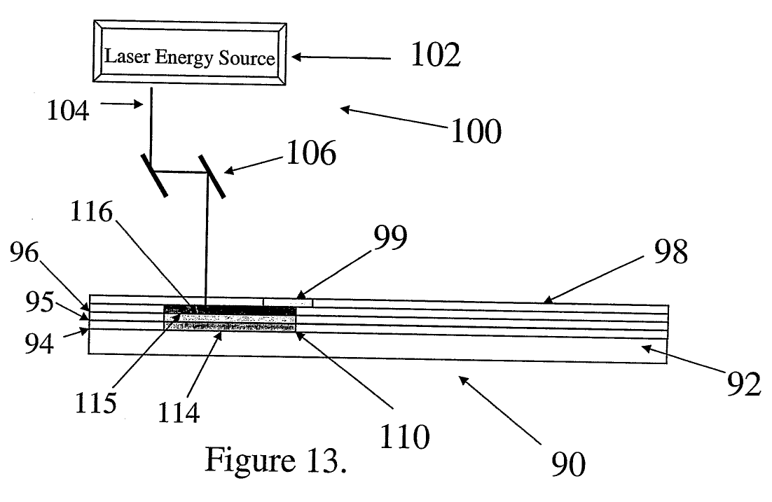

FIG. 13 is a schematic cross-sectional view showing a method of forming multicoloured images and a fixed image in a security document.

FIG. 1 shows an identity document 10 in accordance with the invention which includes a fixed biometric image 12, a laser-formed image 14, variable personalised printed data 16, and laser-formed interlaced images 18.

The identity document shown in FIG. 1 is in the form of a passport sample, with the fixed biometric image 12 in the form of a photograph of the bearer of the document, the laser formed image 14 also in the form of a biometric image of the document bearer, and the personalised data 16 containing information about the bearer such as his name, nationality and date of birth. The interlaced images shown in FIG. 1 are in the form of images of kangaroos at the corners of the fixed biometric image 12.

FIG. 2 shows a sectional view of the identity document 10 of FIG. 1 in which the document is formed from a transparent substrate 20 of polymeric material having a micro-optic film 21 including an array of lenses 22 on one side of the transparent substrate 20, and an inkjet receptive coating 24 on the opposite side of the substrate 20. The inkjet receptive coating 24 includes a laser markable additive evenly dispersed throughout the coating 24. As shown in FIG. 2, the biometric image 14 and the interlaced images 18 are laser formed markings in the inkjet receptive coating, and the fixed biometric image 12 and the variable personalised data 16 are formed by inkjet printing on the coating 24. The inkjet receptive coating is such that the printing ink at least partially penetrates the ink receptive coating so that any attempt to remove the printed image 12 or printed data 16 also results in removal or destruction of the laser-formed biometric image 14 and the interlaced images 18.

Referring to FIG. 3 there is shown a preferred method of creating a laser formed image in the inkjet receptive coating 24 of the identity document of FIG. 2. In FIG. 3, the inkjet receptive coating 24 which includes the laser marking additive is provided on one side of a transparent substrate and exposed to a laser beam 30 from a laser source 32. The laser marking apparatus shown in FIG. 3 may also include a mask 34 and an optics system 36 through which the laser beam passes before it irradiates the areas of the inkjet receptive coating 24 in which the images 14 and 18 are to be provided. An advantage of using a laser to form images in the ink receptive coating is that a laser can be used to create high resolution images outside the realms of conventional printing techniques, eg images having a resolution from about 10 to 60 microns. Therefore, if printed images or data are removed from the inkjet receptive layer, the laser formed images are also altered or removed and it is very difficult to reconstruct the images.

There are a number of different laser marking processes which may be used in the present invention, including:

beam deflection techniques;

mask techniques;

dot matrix techniques; and

laser writing techniques using a scribe laser.

As shown in FIG. 3, the laser marking apparatus 32, 34 and 36 is disposed on the same side of the transparent substrate 20 as the inkjet receptive coating. A micro-optic film including an array of microlenses can then be applied on either side of the transparent substrate for viewing the images 14, 18 formed in the inkjet receptive coating 24.

Referring to FIG. 4, there is shown an alternative method of forming the laser formed images 14, 18 in the inkjet receptive coating 24 in which the laser forming apparatus 32, 34 and 36 is disposed on the same side of the transparent substrate 20 as a micro-optic film 21 including an array of microlenses 22 with the inkjet receptive coating 24 on the opposite side of the substrate so that the laser beam 30 passes through the array of microlenses 22 and through the transparent substrate 20 before forming the images 14, 18 in the inkjet receptive coating 24.

The micro-optic film 21 preferably comprises a base film of transparent polymeric material, such as transparent polyester, though other transparent polymers, eg polypropylene (PP) or polyethylene (PE), could be used. The array of microlenses 22 can be created in the micro-optic film by an embossing process. In a preferred UV embossing process, a UV curable varnish is applied to the transparent substrate which comes into contact with an embossing tool or cylinder having desired lens profiles. The varnish may be cured while in contact with the embossing tool or cylinder by exposure to UV light, eg through the reverse side of the transparent film. The lenses of the microlens array 22 may take a variety of forms depending upon the desired optical effect. For instance, the microlenses may be semi-cylindrical, spherical or semi-spherical, or aspherical.

FIG. 5 shows one form of a preferred optically variable image which may be formed in the inkjet receptive coating 24 in the form of an interlaced image 18. The interlaced image includes spaced first interlaced micro-image portions 41 and alternating second interlaced micro-image portions 42. The form and pitch of the array of microlenses 22 and the micro-image portions 41, 42 are arranged such that when the document is viewed through the array of microlenses 22 from a substantially perpendicular viewing direction, only an image or images formed by the first interlaced micro-image portions 41 are viewable as shown in FIG. 5. When the document is tilted the identification document is viewed from a second oblique angle, the lenses refract light in such a way that it focuses on the second interlaced micro-image portions 42 so that only the interlaced image formed from the second micro-image portions 42 is viewable. The images may be viewed in reflection from the same side of the document as the lenses, or in transmission by viewing from the opposite side of the document from the lenses, such that light from a remote light source passes through the lenses and through the transparent substrate and the transparent or translucent ink receptive coating carrying the image to the viewer.

An example of an interlaced image is also shown in FIG. 6.

The concept of interlaced images is also illustrated by FIGS. 7 and 8 which has a biometric fixed image 50 and first and second variable interlaced images 51 and 52. When the security document 10 is viewed from a first, substantially perpendicular viewing angle, only the first interlaced images 51 which consist of images of kangaroos facing towards the left side of the document 10 are viewable as shown in FIG. 7. As the viewing angle changes from the perpendicular to a more oblique viewing angle, only the second variable images 52 which consist of images of kangaroos facing towards the right hand side of the document 10 are viewable as shown in FIG. 8.

In the modified security document shown in FIG. 9, the microlens array of FIG. 5 is replaced by a line screen 64 printed on the opposite side of the transparent substrate 20 from the inkjet receptive coating 24.

The line screen 64 on one side of the transparent substrate 20 is arranged relative to interlaced image portions 61, 62 on the other side of the substrate such that a first image corresponding to first image portions 61 is visible when the substrate is viewed from a substantially perpendicular viewing angle, and a second image corresponding to the second interlaced image portions 62 is visible when viewed from a second viewing position at an oblique angle to the perpendicular. This creates an optically variable effect in which different interlaced images are viewable from different viewing angles as illustrated in FIG. 9. Although FIGS. 7 to 9 only show two interlaced images, 51, 52 formed from first and second image portions 41, 42; 61, 62, additional interlaced images may be provided, if required.

In an alternative embodiment similar to that of FIG. 2, one of the images 14, 18 may be replaced by a “floating image” which appears to float above or below the plane of the identification document 10. The floating image may be created when the micro-lens array 22 consists of aspherical micro-lenses with an array of micro images having the same pitch as the micro-lens array formed in the inkjet receptive coating 24. The floating image optical effect produced in this manner is also known as moire magnification. In an alternative method of producing a floating image, the micro-lenses of the micro-lens array may have other shapes, eg spherical, semi-spherical or semi-cylindrical, with the array of microimages created by diverging or converging laser radiation which is directed onto the inkjet receptive coating 24 including the laser marking additive to form the microimages in the inkjet receptive coating.

Referring to FIG. 10, there is shown another preferred embodiment of a security document 70 which incorporates a transparent window 76 in addition to at least one laser formed image 75. The security document 70 is formed from a transparent substrate 72 having a translucent inkjet receptive layer 74 on at least one surface of the substrate 72. The transparent window 76 can be formed by applying the translucent inkjet receptive coating 74 on the substrate 72 in areas outside the region of the window 76. As shown in FIG. 10, a laser formed image 75 is provided in the translucent inkjet receptive layer 74, and a transparent inkjet receptive layer 78 is applied over the translucent inkjet receptive layer 74 and the area of the transparent window 76. Variable biometric or personalised data 79 can then be applied by inkjet printing over either or both of the transparent and translucent parts of the security document so that the biometric or personalised data is visible from both sides of the document. As shown in FIGS. 10 and 11, the inkjet printed biometric data 79 extends into both the transparent window 76 and the surrounding translucent part of the security document to which the translucent layer 74 has been applied. The transparent and translucent inkjet receptive layers 74 and 78 are preferably applied in such a manner that the inkjet ink penetrates into not only the transparent inkjet receptive layer 78, but also the translucent inkjet receptive layer 74 below. Therefore, upon an attempt to remove or alter the printed biometric data 79, the laser formed image 75 and/or the transparent window 76 will be destroyed making it evident that an attempt has been made to tamper with the security document, and making it difficult to fraudulently alter the document.

It will be appreciated that various modifications may be made to the embodiment illustrated by FIGS. 10 and 11. For example, the transparent inkjet receptive coating may also include a laser markable additive so that a laser formed image may be created in the area of the transparent window 76. Also, the transparent inkjet receptive layer 78 may be applied only in the area of the transparent window 76, instead of all over the substrate 72. Further, the relative positions of the translucent and transparent inkjet receptive layers 74 and 78 could be reversed so that the translucent coating is on top of the transparent coating. Also, the transparent window 76 could be created by laser ablation of the translucent inkjet receptive layer 74 applied over all of the area of the substrate 72, rather than by selective application of the translucent inkjet receptive layer 74 outside the area of the transparent window 76.

Referring to FIG. 12, there is shown another embodiment of a security document 80 in which the laser formed image 86 in the transparent or translucent inkjet receptive layer 84 forms a first image part of a see-through feature on one side of the transparent substrate 82, with a second image part 88 of the composite see-through feature being provided on the opposite side of the substrate 82.

As shown in FIG. 12, variable biometric personalised inkjet printed data 89 is applied to the inkjet receptive layer 84 in the area of the laser formed part image 86 so that if the variable biometric or personalised inkjet printed data is removed, part of the see-through composite image is removed which makes it difficult for a person to alter the document whilst maintaining the see-through composite image.

The second image part 88 of the see-through composite image may be formed by printing or by laser marking, eg in another transparent or translucent inkjet receptive layer applied to the opposite side of the transparent substrate 82 from the inkjet receptive layer 84, or by some other laser marking process. If the second image part 88 is formed by laser marking it create an indelible part of the image such that it cannot be removed unless the document is destroyed.

Referring to FIG. 13, there is shown a security document 90 formed from a transparent substrate 92 with first, second and third colour forming coatings 94, 95 and 96 respectively applied on one side of the substrate 90, and a coating 98 including a laser forming additive in which a permanent or fixed image is laser-formed, preferably in the same manner as described with reference to FIG. 3.

Each of the colour forming layers 94, 95 and 96 include a different latent colour forming compound or pigment so that coloured part images 114, 115 and 116 can be respectively formed in each of the layers 94, 95 and 96 by exposure to laser radiation from appropriate laser marking equipment 100. The different coloured part images 114, 115 and 116 together constitute a multi-coloured biometric image 110, such as a coloured photograph or facial image of the bearer of the security document 90. For example, the colour forming layer 94 may incorporate a green colour forming compound, the second layer 95 may include a blue colour forming compound and the third colour forming layer may include a red colour forming compound in order to produce the multicoloured image.

The laser system 100 includes a laser energy source 102 which produces a laser beam 104, and an x-y mirror deflection unit 106 which can be used to write the respective image parts 114, 115, 116 in the colour forming layers 94, 95, 96.

Examples of latent colour forming compounds or pigments suitable for use in the colour forming layers 94, 95 and 96 are pigments manufactured by CIBA which can develop a colour when irradiated with a laser emitting UV light. Such colour forming pigments may include a latent acid, a colour former and optionally further ingredients such as described in WO 02/101462. Other examples of suitable colour forming pigments include the IRIODIN LS (laser sensitive) range of pigments. IRIODIN is a registered trade mark of Merck KGA. The principle of colour formation with IRIODIN LS pigment is based on a carbonisation and surface forming between TiO₂ coated mica pigments, the polymer and the laser energy. Typically such pigments develop colour when irradiated with a laser emitting infrared radiation.

The latent colour forming pigments may be blended as a polymer master batch and manufactured into a polymeric film of polypropylene, polyethylene, polyester or copolymers of polypropylene/ethylene/butylene. The latent colour forming pigments are preferably present in the layers of transparent or translucent polymeric material in concentrations which are sufficiently low so as not to affect the transparency or translucency of the polymeric material. Preferably, the concentration of colour forming pigment in the polymeric material falls substantially within the range from about 2% to about 10% by weight of the polymeric material. The latent colour forming pigments may also be added directly into solvent based coatings and applied to transparent polymeric films of the type described above. The coatings may be applied in thicknesses falling substantially within the range from 5 to 30 gsm for each colour forming layer.

The permanent or fixed image 99 may be laser formed in the coating 98 using a separate laser system similar to that described with reference to FIG. 3. The coating 98 is preferably an ink receptive coating which includes a laser markable additive that forms a monochrome grey/black marking when exposed to laser radiation, eg as described with reference to FIG. 3. However, the coating 98 need not necessarily be an inkjet receptive coating.

The layers 94, 95 and 96 incorporating the laser-formed multi-coloured image 110 and the coating 98 incorporating the laser-formed permanent or fixed markings or image 99 are preferably applied to the transparent substrate 92 in such a way that an attempt to remove or alter the permanent or fixed laser marked image 99 results in removal or destruction of the layers 94, 95 and 96 and the associated multi-coloured biometric image 110.

It will be appreciated that in the various embodiments described above there is provided a tamper evident security document which has at least one security element in the form of a laser formed image in a coating with data such as biometric variable data permanently formed in the security document, eg by inkjet printing or by laser-forming a multi-coloured image whereby an attempt to remove or alter biometric variable data also results in removal or destruction of the permanent or fixed laser-formed marking or image.

It will also be appreciated that various modifications and/or additions may be made to anyone or more of the documents described above without departing from the scope and spirit of the present invention. For instance, two or more of the various types of optical security features or images described above in the different embodiments may be combined in a single security document.

1-52. (canceled)

53. A tamper evident security document including:
a transparent substrate;
an ink receptive coating applied to at least one side of the substrate, said coating including a laser markable additive dispersed therein;
at least one laser formed marking or image created in the coating by exposure of the laser markable additive to laser radiation; and
printed data applied to the ink receptive coating;
wherein the marking or image in the coating is removed or destroyed upon an attempt to alter the printed data.

54. A security document according to claim 53 wherein the ink receptive coating is transparent or translucent so that the printed data is visible from both sides of the security document.

55. A security document according to claim 53 wherein the ink receptive coating is adapted for printing by digital output devices, such as inkjet printers or laser toners.

56. A security document according to claim 53 wherein the laser markable additive forms a monochrome marking in the ink receptive coating when exposed to laser radiation.

57. A security document according to claim 53 wherein the laser formed marking or image in the ink receptive coating is an optical security element.

58. A security document according to claim 57 wherein the optical security element includes at least one micro-image, and a lenticular array or an array of microlenses is provided on the security document for viewing the micro-image.

59. A security document according to claim 58 wherein the laser formed marking or image is an optically variable security element in the form of a plurality of interlaced images and the lenticular array is a lens array or a printed line screen whereby different images of the optically variable security element are viewable at different viewing angles.

60. A security document according to claim 58 wherein the lenticular array is a lens array in the form of a semi-cylindrical lens array or an aspherical micro-lens array.

61. A security document according to claim 57 wherein the laser formed optical security element includes an array of micro-images which when viewed through a micro-lens array create a floating image effect, or a moire magnification effect.

62. A security document according to claim 53 wherein the laser formed marking or image is provided on one side of the document to form a first part of a see-through composite image, with a second part of the see-through composite image provided on the opposite side of the document.

63. A security document according to claim 63 including a plurality of colour forming layers, each including a different colour forming pigment.

64. A security document according to claim 63 wherein different coloured parts of an image are formed in the different colour forming layers by exposure to laser radiation and a multicoloured image is formed by the different coloured image parts where two or more of the layers are superimposed.

65. A security document according to claim 63 wherein at least one of the colour forming layers includes an ink receptive coating in which printed data is formed.

66. A security document according to claim 63 wherein a further ink receptive coating including a laser markable additive is provided in which a laser formed optical security element and printed data are formed.

67. A method of manufacturing a tamper evident security document including the steps of:
providing a transparent substrate;
applying an ink receptive coating to at least one side of the substrate, said coating having a laser markable additive dispersed therein;
creating at least one marking or image in the ink receptive coating by irradiating the laser markable additive with laser radiation; and
applying printing ink to the ink receptive coating to form printed data, wherein the ink at least partially penetrates the ink receptive coating so that the laser formed marking or image in the coating is removed or destroyed upon an attempt to remove or alter the printed data.

68. A method of manufacturing a tamper evident security document according to claim 67 wherein the ink receptive coating is an inkjet receptive coating formed from a polymer-based material which includes a modified acrylic-based polymer, water and isopropyl alcohol, and the ink receptive coating being cationic to make it receptive to anionic inkjet dyes.

69. A method of manufacturing a tamper evident security document according to claim 67 wherein the laser markable additive, includes an inorganic water dispersible pigment.

70. A method of manufacturing a tamper evident security document according to claim 67 wherein the laser markable additive is added to the ink receptive coating in concentrations falling substantially within the range from about 10-30% by weight of the total weight of the formulation.

71. A method according to claim 67 wherein a lenticular array or an array of microlenses is formed on one side of the substrate.

72. A method according to claim 71 in which the at least one laser formed marking or image is created in the ink receptive coating after the array of microlenses is applied, and at least one laser formed marking or image is created by exposure to laser radiation which passes through the lenticular array or the array of microlenses.

73. A tamper evident security document including:
a transparent substrate;
a plurality of laser markable layers, each including a different colour forming pigment;
coloured laser formed part images formed by laser marking in the laser markable layers which part images together constitute a multi-coloured biometric image when superimposed;
a coating including a laser formed permanent image,
wherein an attempt to alter or remove the laser formed permanent image results in removal or destruction of at least one of the laser markable layers and part of the laser formed multicoloured biometric image formed therein.

74. A method of manufacturing a tamper evident security document including the steps of:
providing a transparent substrate;
applying a plurality of laser markable layers on at least one side of the substrate, each layer including a different colour forming pigment;
exposing each of the laser markable layers to radiation to form coloured part images in different colours in the laser markable layers, the coloured part images together constituting a multi-coloured biometric image;
applying another laser markable coating on the same side of the substrate as at least one of the laser markable layers; and
laser forming a permanent image in the laser markable coating in such a manner that an attempt to alter or remove the permanent image in the laser markable coating results in removal or destruction of at least one of the laser markable layers including part of the laser formed multi-coloured biometric image formed therein.
